(19) United States
(12) Patent Application Publication
(10) Pub. No.: US 2026/0310736 A1
(43) Pub. Date: Oct. 8, 2026

(54) ARTIFICIAL INTELLIGENCE (AI) AGENT FOR PROACTIVE INTEGRATION RECOMMENDATIONS

(71) Applicant: BOOMI, LP, Conshohocken, PA (US)

(72) Inventor: Sreekanth Venkateshwara CHINTALA, Bangalore (IN)

(73) Assignee: BOOMI, LP, Conshohocken, PA (US)

(21) Appl. No.: 19/170,679

(22) Filed: Apr. 4, 2025

(51) Int. Cl. G06F 16/9535; G06F 16/901; G06F 16/9538; G06F 21/41

(52) U.S. Cl. CPC G06F 16/9535; G06F 16/9024; G06F 16/9538; G06F 21/41

(57) ABSTRACT

There has been progress towards making integration platform as a service (iPaaS) more accessible to novice users, using low-code integration-development environments. However, such users may easily miss opportunities for integrations within their integration platforms. Accordingly, disclosed embodiments provide an artificial intelligence (AI) agent that is capable of proactively reaching out to a user, and automatically identifying gaps within the user's integration platform, recommending integrations to solve those gaps, and generating an integration process to automate each recommend integration.

### BACKGROUND

### Field of the Invention

The embodiments described herein are generally directed to artificial intelligence, and, more particularly, to an artificial intelligence (AI) agent that provides proactive integration recommendations.

### Description of the Related Art

Integration Platform as a Service (iPaaS) enables the integration of applications and data. The iPaaS platform provided by Boomi® of Conshohocken, Pennsylvania, enables users to construct integration processes from pre-built steps, visually represented as “shapes,” which each has a set of configurable properties. Each step dictates how an integration process retrieves data, manipulates data, routes data, sends data, and/or the like. These steps can be connected together in endless combinations to build simple to very complex integration processes. Such a tool enables even novice users to build and maintain an integration platform.

However, while such an iPaaS platform empowers novice users to build and manage their own integration platforms, such users may miss opportunities for integrations within their integration platforms. In particular, their integration platforms may include gaps between their existing services that could be solved with appropriate integrations. Accordingly, what is needed is a recommendation engine that can proactively identify such gaps in users'integration platforms and recommend integrations to fill those gaps.

### SUMMARY

Accordingly, systems, methods, and non-transitory computer-readable media are disclosed for an artificial intelligence (AI) agent that provides proactive integration recommendations.

In an embodiment, a method comprises using at least one hardware processor to, by an artificial intelligence (AI) agent, during a real-time chat session between a user and the AI agent within a chat frame of a graphical user interface: perform a diagnostics test by retrieving a list of software services utilized by the user via an application programming interface of a service management system, and query a graph database to identify one or more connectable sets of software services in the retrieved list of software services, wherein the graph database represents a graph comprising nodes and edges, in which each node represents a software service utilized within a computing environment of an integration as a service (iPaaS) platform, and in which each edge represents a connection implemented between a pair of the software services within the computing environment; generate a recommendation based on the identified one or more connectable sets of software services, wherein the recommendation comprises one or more recommended integrations, and wherein each of the one or more recommended integrations represents an integration of data between one of the one or more connectable sets of software services; and display a visual representation of the recommendation in the chat frame.

The diagnostics test may be performed in response to a user input from the user within the chat frame. The user input may be prompted by an initial agent input from the AI agent within the chat frame. The initial agent input may be predefined. The chat frame may be opened and the initial agent input may be entered into the chat frame in response to a trigger. The trigger may be an event that indicates that the user is attempting to create an integration process.

The visual representation may comprise a natural-language expression. The method may further comprise using the at least one hardware processor to, by the AI agent, generate the natural-language expression by: generating a prompt based on the one or more connectable sets of software services; and inputting the prompt to a generative language model to produce the natural-language expression.

The method may further comprise using the at least one hardware processor to, by the AI agent, receive a user selection, within the chat frame, of at least one of the one or more recommended integrations. The method may further comprise using the at least one hardware processor to, in response to the user selection of the at least one recommended integration, perform the integration of data between the one of the one or more connectable sets of software services that is represented by the at least one recommended integration. The method may further comprise using the at least one hardware processor to, by the AI agent, prompt the user, within the chat frame, to generate an integration process that automates the at least one recommended integration. The method may further comprising using the at least one hardware processor to: receive a user affirmation, within the chat frame, to generating the integration process; and in response to the user affirmation, generate the integration process. The method may further comprise using the at least one hardware processor to, in response to a user selection of an input within the chat frame, redirect the user to a screen within the graphical user interface that comprises a virtual canvas on which shapes, representing pre-built elements of the generated integration process, are pre-positioned and pre-connected, wherein each of the shapes is draggable and droppable within the virtual canvas.

The visual representation may comprise, for each of the one or more recommended integrations, an identifier of each software service in the connectable set of software services between which the recommended integration represents the integration of data. The visual representation may further comprise, for each of the one or more recommended integrations, a value of each of one or more metrics associated with that recommended integration. The value of at least one of the one or more metrics may be derived from historical data collected from a plurality of implementations of integration processes, managed by a plurality of users, within the computing environment.

The method may further comprise using the at least one hardware processor to build the graph database from historical implementations of integration processes, managed by a plurality of users, within the computing environment.

The service management system may comprise a centralized sign-on service.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example process for proactively recommending integrations by an artificial intelligence (AI) agent, according to an embodiment;

FIG. 4 illustrates a diagnostics process, according to an embodiment; and

FIGS. 5A-5D illustrate a graphical user interface of an AI agent for proactively recommending integrations, according to an embodiment.

### DETAILED DESCRIPTION

In an embodiment, systems, methods, and non-transitory computer-readable media are disclosed for an artificial intelligence (AI) agent that provides proactive integration recommendations. The AI agent represents a service that can reach out to a user, in order to help that user understand the software services to which the user is subscribed, and recommend new integrations to fill gaps in the user's integration platform. Accordingly, the AI agent is a powerful tool that can unlock the potential of normally siloed customer data by integrating the data between systems to produce a synergy.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

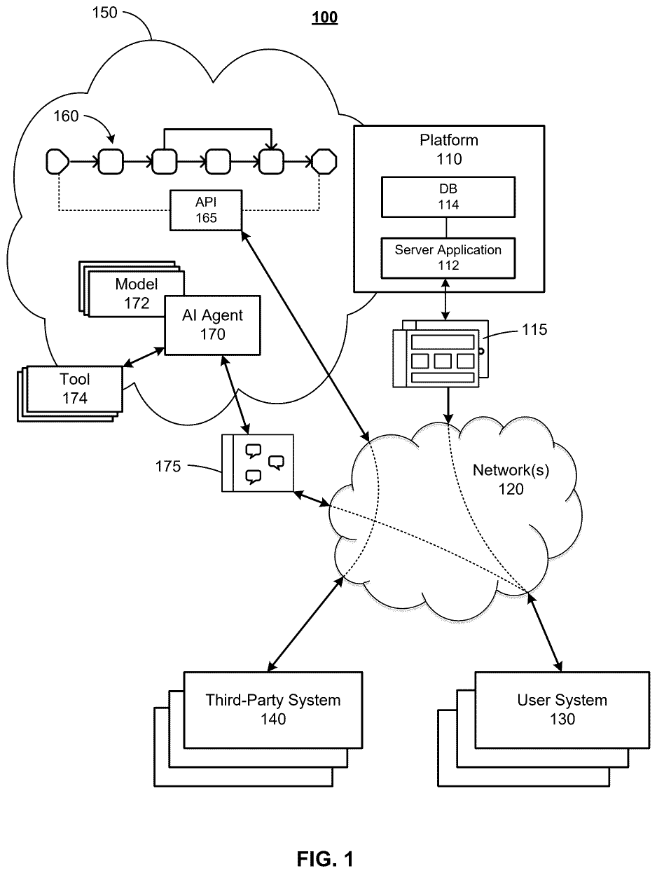

FIG. 1 illustrates an example infrastructure 100, in which one or more of the processes described herein may be implemented, according to an embodiment. Infrastructure 100 may comprise a platform 110 which hosts and/or executes one or more of the disclosed processes, which may be implemented in software and/or hardware. In particular, platform 110 may execute a server application 112 and/or host a database 114 that may store data used by server application 112. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and user system(s) 130 and/or third-party system(s) 140. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 and/or third-party systems 140 through a single set of network(s) 120, it should be understood that platform 110 may be connected to different user systems 130 and/or third-party systems 140 via different sets of one or more networks. For example, platform 110 may be connected to a subset of user systems 130 and/or third-party systems 140 via the Internet, but may be connected to another subset of user systems 130 and/or third-party systems 140 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal or professional workstation of an integration developer that has a user account for accessing server application 112 on platform 110. It should be understood that the integration developer may be anywhere from a novice, with little to no prior experience in integration development, to an expert, with many years of experience in integration development. When platform 110 is an iPaaS platform, each user account may be associated with an overarching organizational account for managing an integration platform on the iPaaS platform.

Server application 112 may manage a computing environment 150, which may comprise an integration environment. In particular, server application 112 may provide a user interface 115 and backend functionality, including one or more of the processes disclosed herein, to enable users, via user systems 130, to construct, develop, modify, save, delete, test, deploy, un-deploy, and/or otherwise manage integration processes 160 within computing environment 150. User interface 115 may comprise a graphical user interface that implements a low-code environment, including potentially a no-code environment, in which users may construct integration processes 160.

The user of a user system 130 may authenticate with platform 110 using standard authentication means, to access server application 112 in accordance with permissions or roles of the associated user account. The user may then interact with server application 112 to manage one or more integration processes 160, for example, within a larger integration platform within computing environment 150. It should be understood that multiple users, on multiple user systems 130, may manage the same integration process(es) 160 and/or different integration processes 160 in this manner, according to the permissions or roles of their associated user accounts.

Although only a single integration process 160 is illustrated, it should be understood that, in reality, computing environment 150 may comprise any number of integration processes 160. In an embodiment, computing environment 150 supports integration platform as a service (iPaaS). In this case, computing environment 150 may comprise one or a plurality of integration platforms that each comprises one or a plurality of integration processes 160. Each integration platform may be associated with an organization, which may be associated with one or more user accounts by which respective user(s) manage the organization's integration platform, including the various integration process(es) 160.

An integration process 160 may represent a transaction involving the integration of data between two or more systems, and may comprise a series of elements or components that specify logic and transformation requirements for the data to be integrated. Each element, which may also be referred to herein as a “step” and have a visual representation referred to herein as a “shape,” may transform, route, and/or otherwise manipulate data to attain an end result from input data. For example, a basic integration process 160 may receive data from one or more data sources (e.g., via an application programming interface 162 of the integration process 160), manipulate the received data in a specified manner (e.g., including mapping, analyzing, normalizing, altering, updating, enhancing, and/or augmenting the received data), and send the manipulated data to one or more specified targets (e.g., via an application programming interface of each target). An integration process 160 may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

The functionality of server application 112 may include a process for constructing an integration process 160 within one or more screens of a graphical user interface of user interface 115. Embodiments of such functionality are disclosed, for example, in U.S. Pat. No. 8,533,661, issued on Sep. 10, 2013, and U.S. Pat. No. 11,886,965, issued on Jan. 30, 2024, which are both hereby incorporated herein by reference as if set forth in full, and referred to hereafter as “the GUI patents.” In particular, the GUI patents describe functionality that enable the construction of integration processes 160 on a virtual canvas.

Each integration process 160, when deployed, may be communicatively coupled to network(s) 120. For example, each integration process 160 may comprise an application programming interface (API) 162 that enables clients to access integration process 160 via network(s) 120. A client may push data to integration process 160 through application programming interface 162, and/or pull data from integration process 160 through application programming interface 162.

One or more third-party systems 140 may be communicatively connected to network(s) 120, such that each third-party system 140 may communicate with an integration process 160 in computing environment 150 via application programming interface 162. Third-party system 140 may host and/or execute a software application that pushes data to integration process 160 and/or pulls data from integration process 160, via application programming interface 162. Additionally or alternatively, an integration process 160 may push data to a software application on third-party system 140 and/or pull data from a software application on third-party system 140, via an application programming interface of the third-party system 140. Thus, third-party system 140 may be a client or consumer (e.g., target) of one or more integration processes 160, a data source for one or more integration processes 160, and/or the like. As examples, the software application on third-party system 170 may comprise, without limitation, enterprise resource planning (ERP) software, customer relationship management (CRM) software, accounting software, and/or the like.

Computing environment 150 may also comprise one or more artificial intelligence (AI) agents 170. Each AI agent 170 may comprise or be communicatively connected (e.g., via an application programming interface) to one or more models 172. Additionally or alternatively, an AI agent 170 may be communicatively connected to one or more tools 174 (e.g., via an application programming interface of each tool 174). Tool 174 may be hosted within computing environment 150 or on a system that is external to computing environment 150 (e.g., an on-premises system, third-party system 140, etc.). AI agent 170 may utilize model(s) 172 and/or tool(s) 174 to perform a task assigned to the AI agent 170.

Of particular relevance to disclosed embodiments, computing environment 150 may comprise an AI agent 170 that, as its task, recommends integration processes 160 for a user's integration platform that is hosted within computing environment 150. AI agent 170 may provide these recommendations via a user interface 175. User interface 175 may be comprised within user interface 115 of platform 110, or may be separate and distinct from user interface 115. It is contemplated that AI agent 170 would implement a real-time chat session within a chat frame of user interface 175. This chat frame may be overlaid on or otherwise visually integrated into a graphical user interface of user interface 115. Alternatively or additionally, the real-time chat session could be implemented within an audio interface of user interface 175. In this case, a user's speech may be converted into text (e.g., via a speech-to-text engine) and/or text generated by AI agent 170 may be converted into speech (e.g., via a text-to-speech engine), within the audio interface. In yet another alternative, the real-time chat session could be implemented within an audiovisual interface of user interface 175, which combines a graphical user interface with an audio interface. In any case, a user may interface with AI agent 170 using natural language. As used herein, the term “natural language” or “natural-language” refers to language, including grammar, that would be expected in a normal conversation between two humans.

### 2. Example Processing System

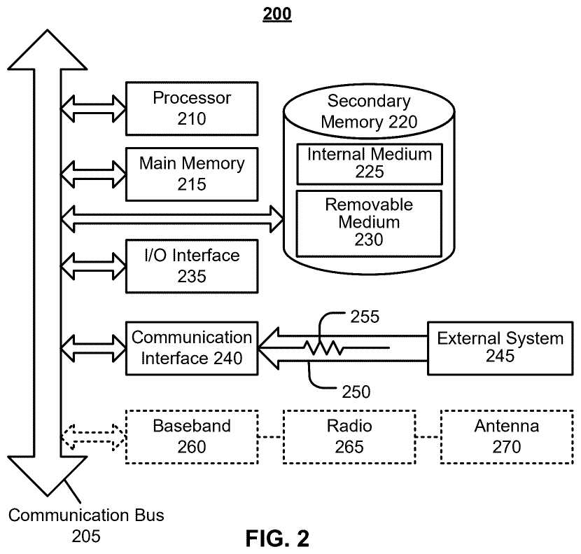

FIG. 2 illustrates an example processing system 200, by which one or more of the processes described herein may be executed, according to an embodiment. For example, system 200 may be used to store and/or execute server application 112, integration process 160, and/or AI agent 170, and/or may represent components of platform 110, user system(s) 130, third-party system 140, computing environment 150, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Overall Process

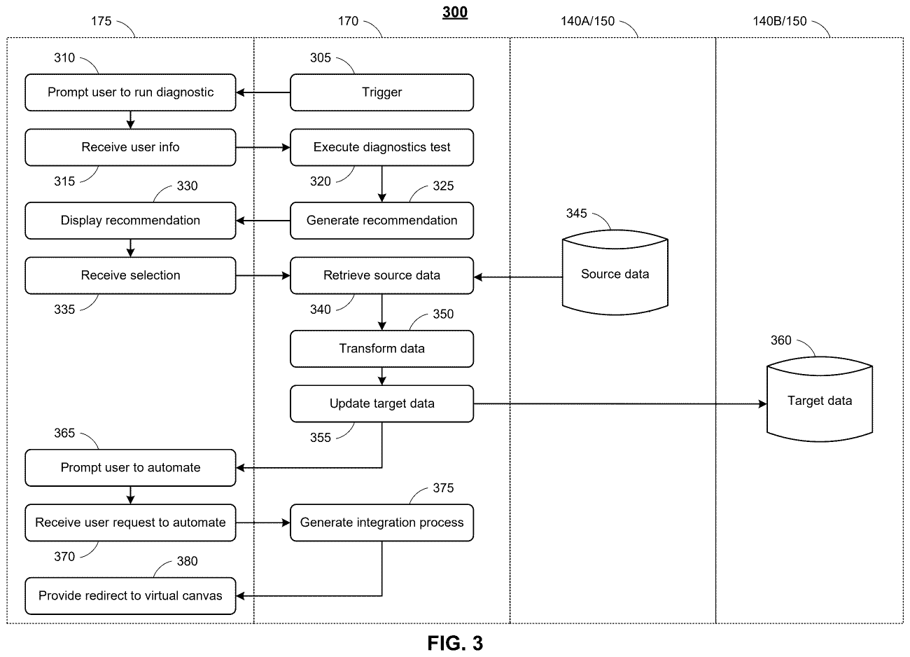

FIG. 3 illustrates an example process 300 for proactively recommending integrations by AI agent 170, according to an embodiment. User interface 175 (i.e., the front-end) of AI agent 170 may implement modules 310, 315, 330, 335, 365, 370, and 380, and the backend of AI agent 170 may implement modules 305, 320, 325, 340, 350, 355, and 375. These modules are preferably implemented as software modules, but could also be implemented as hardware modules or as modules comprising a combination of hardware and software. While process 300 is illustrated with a certain arrangement and ordering of modules, process 300 may be implemented with fewer, more, or different modules and a different arrangement and/or ordering of modules. Furthermore, any module, which does not depend on the completion of another module, may be executed before, after, or in parallel with that other independent module, even if the modules are described or illustrated in a particular order.

Initially, AI agent 170 may be triggered by module 305. The trigger may be the user logging in to a user account on platform 110, selecting an input within a dashboard or other screen of the graphical user interface of user interface 115, navigating to a particular screen of the graphical user interface of user interface 115, searching for an integration or connector, the occurrence of an event while the user is logged into the user account, and/or the like. In an embodiment, the trigger is an event that indicates the user is attempting to create an integration process 160. When triggered, AI agent 170 may open a graphical user interface of user interface 175. This graphical user interface may comprise a chat frame, within which the user can converse and/or otherwise interact with AI agent 170.

The conversation may occur in natural language. For example, AI agent 170 may utilize a model 172 to process the inputs from the user, generate natural-language responses to the user's inputs, generate natural-language queries for information from the user, and/or the like. For example, model 172 may comprise a generative language model, such as a large language model. One well-known example of a large language model is the Generative Pre-trained Transformer (GPT). GPT-4 is the fourth-generation language prediction model in the GPT-n series, created by OpenAI™ of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the Claude family of large language models (e.g., Claude 3 Opus) developed by Anthropic PBC of San Francisco, California, the Falcon large language model (e.g., Falcon 180B) released by the United Arab Emirates'Technology Innovation Institute (TII), the Large Language Model Meta AI (LLaMA) model (e.g., LLaMA 2) released by Meta AI of New York, New York, the Gemini model, the Mistral family of models released by Mistral AI of Paris, France, and the like. Alternatively or additionally, the generative language model may comprise or consist of a code-completion model that is trained to produce source code, data structures represented in a markup language (e.g., XML, HTML, etc.) or other format, and/or the like. A pre-trained generative language model may used as a base model that is fine-tuned for the specific task of recommending integrations.

To automatically generate the natural-language expressions, AI agent 170 may generate a prompt by inserting relevant data into a predefined template. The predefined template may comprise a pre-conversation and/or post-conversation, which provide context and/or instructions for the generative language model, and a placeholder into which the relevant data are inserted. The pre-conversation and/or post-conversation may define the role of the generative language model (e.g., to acquire certain data, to summarize acquired data, etc.), define an output format for the generative language model (e.g., a list structure, a hierarchical structure, a markup-language structure, etc.), and/or the like. AI agent 170 may input the generated prompt to the generative language model to produce an output, which may comprise a natural-language expression, a data structure representing a visual dialog to be rendered in user interface 175, and/or the like.

The trigger by module 305 may instantiate a real-time chat session between the user and AI agent 170. In particular, in response to the trigger by module 305, a chat frame may be opened within the graphical user interface of user interface 175 and an initial agent input may be entered into the chat frame. For example, module 310 may prompt the user to run a diagnostic, as the initial agent input. This initial agent input may be predefined (e.g., a predefined prompt that AI agent 170 always uses to initiate the chat session), or may be dynamically generated by model 172 (e.g., a generative language model) in real time. The initial agent input may comprise a query in the chat frame of the real-time chat session that asks the user whether or not the user would like to perform a diagnostics test of the health of the integration platform managed by the user. The user may indicate acceptance or rejection of the diagnostics test by entering a natural-language user input into the chat frame, in response to the initial agent input. If the user input accepts the diagnostics test, user information may be collected by module 315 and a diagnostics test may be performed by module 320, in response to the user input from the user within the chat frame. On the other hand, if the user input rejects the diagnostics test, process 300 may end.

In an alternative embodiment, the initial agent input may be provided in a pop-up dialog frame. In this case, the pop-up dialog frame may comprise an input for accepting the diagnostics test and/or an input for rejecting the diagnostics test. In this embodiment, selection of the input for accepting the diagnostics test may instantiate the real-time chat session between the user and AI agent 170, and open the chat frame within the graphical user interface of user interface 175. Again, if the user input accepts the diagnostics test, user information may be collected by module 315 and a diagnostics test may be performed by module 320, in response to the user input from the user within the chat frame. On the other hand, if the user input rejects the diagnostics test, process 300 may end.

Module 315 may receive user information from the user. In particular, module 315 may prompt the user for the user information. Again, the prompt may be a predefined prompt (e.g., that AI agent 170 always uses to request the user information), or may be dynamically generated by model 172 (e.g., a generative language model) in real time. The prompt may comprise a query in the chat frame of the chat session or may comprise a pop-up dialog frame with one or more input fields for entering the user information. In either case, the prompt may request certain user information from the user. This user information may comprise an address of an application programming interface of a service management system. The service management system may comprise a same-sign-on service, single-sign-on service, or other centralized sign-on service, such as the system provided by Okta, Inc. of San Francisco, California. A centralized sign-on service enables a user to authenticate with a plurality of independent software services via a centralized sign-on process. The user information may also comprise credentials (e.g., user name and password, identifier and secret, etc.) for authenticating with the application programming interface of the service management system (e.g., centralized sign-on service). It should be understood that the user information may comprise additional or alternative information, including any other user information required as inputs to the diagnostics tests. In addition, the user information may be received in a single interaction with the user or a plurality of interactions with the user (e.g., via natural-language conversation in the chat frame). Essentially, AI agent 170 may walk the user through all of the steps required to connect to the service-management application programming interface.

Of particular relevance to disclosed embodiments, the service management system (e.g., centralized sign-on service) may maintain a directory of all of the software services which the user utilizes (e.g., which the user is subscribed). The application programming interface of the service management system may comprise a function for retrieving a list of all software services in the directory of software services. Thus, the list of software services, utilized by the user, may be retrieved via a call to the function of the service-management application programming interface. The service-management application programming interface may be designed to include such a function from the start, or such a function may be added to an existing application programming interface of the service management system.

Once the user information has been received, module 320 may execute the diagnostics test. The diagnostics test will be described in greater detail elsewhere herein. At a high level, the diagnostics test retrieves a list of software services utilized by the user (e.g., via an application programming interface of the service management system), identifies connections, within crowd-sourced historical data, between sets of software services in the list of software services that are not already implemented as integration processes 160 on the user's integration platform, and outputs one or more of those identified sets of software services as a recommended integration. As will be described in greater detail elsewhere herein, the crowd-sourced historical data may be represented in a graph database that is queried, using the list of software services utilized by the user, during the diagnostics test. It should be understood that each recommended integration can be implemented by an integration process 160, but has not yet been implemented by the user and may not have even been conceived by the user.

In an embodiment, a recommended integration comprises a set of software services, utilized by the current user, that other users connected to each other, as determined from the crowd-sourced historical data, but which the current user has not connected to each other. Thus, each recommended integration comprises a connectable set of software services. It is generally contemplated that a set of software services would consist of a pair of software services (i.e., two software services). However, a set of software services could alternatively consist of a single software service, or three or more software services connected together. In addition, a pair of software services could consist of a single software service that is both the source and the target of an integration (e.g., to clean, normalize, augment, or otherwise transform data managed by the software service).

Module 325 may generate a recommendation based on connectable set(s) of software services, identified by the diagnostics test executed in module 320. Each connectable set of software services represents a candidate integration. When only a single candidate integration is identified by module 320, the recommendation may consist of that single candidate integration. When a plurality of candidate integrations are identified by module 320, the recommendation may comprise all of the plurality of candidate integrations or a subset of one or more of the plurality of candidate integrations. In the case that the recommendation comprises a plurality of candidate integrations, the plurality of candidate integrations may be ranked according to one or more factors, such as one or more metrics for each candidate integration, derived from the crowd-sourced historical data. Examples of a metric include, without limitation, the frequency (e.g., number or percentage of occurrences) of each integration within the crowd-sourced historical data, the utilization rate of each integration, the performance of each integration, the business value of each integration, the volume of data that flows through each integration, and the like. A subset of the plurality of top-ranked candidate integrations may then be selected from the ranked plurality of candidate integrations. The top-ranked candidate integrations may be a predefined number (e.g., one, three, five, ten, etc.) of integrations having the highest ranks, those integrations whose metric(s) satisfy (e.g., are greater than or equal to, or less than, depending on the metric) respective predefined thresholds, and/or the like. It should be understood that, in an embodiment in which the predefined number is one, only the highest-ranked integration is recommended. In any case, the recommendation may comprise one or more recommended integrations, which each represents an integration of data between a connectable set of software services identified by the diagnostics test executed in module 320.

In an embodiment in which AI agent 170 utilizes a generative language model (e.g., as model 172) to generate natural-language expressions, module 325 may generate the recommendation by inserting the output of module 320, which may comprise a list of one or more integrations (e.g., connectable set(s) of services), into a predefined template. The predefined template may comprise a pre-conversation and/or post-conversation, which provide context and/or instructions for the generative language model, and a placeholder into which the recommended integration(s), output by module 320, are inserted. The pre-conversation and/or post-conversation may instruct the generative language model to summarize the recommended integration(s) and/or the like. Module 325 may input the generated prompt to the generative language model to produce an output, which may comprise the natural-language expression. In other words, the natural-language expression may be generated, by AI agent 170, by generating a prompt based on the one or more connectable sets of software services, output by module 320 as recommended integrations, and inputting the prompt to a generative language model to produce the natural-language expression.

It is possible that the diagnostics test, executed by module 320, may output no recommended integrations. This may happen in the event that the crowd-sourced historical data contain no integrations, between sets of software services utilized by the user, that have not already been implemented by the user. In this case, the recommendation may simply indicate that there are no recommended integrations and/or that the user's integration platform is healthy.

Module 330 may display a visual representation of the recommendation, that was generated by module 325, as a result of the diagnostics test. In particular, module 330 may display the visual representation of the recommendation in the chat frame of user interface 175, within the context of the real-time chat session. As discussed above, this recommendation may comprise or consist of a natural-language expression, which, for example, summarizes one or more recommended integrations. The summary of each recommended integration may comprise an identifier (e.g., name) of each software service in the connectable set of software service(s) between which the recommended integration represents the integration of data, the value of each of one or more metrics associated with the recommend integration (e.g., calculated for the integration, such as frequency, utilization rate, performance, value, data volume, etc.), and/or the like. The value of at least one, and potentially, all of these metric(s) may be derived from the crowd-sourced historical data collected from a plurality of implementations of integration processes 160, managed by a plurality of users, within computing environment 150. The recommendation may also prompt the user to select at least one of the recommended integration(s), via a response within the real-time chat session or via an input that is provided in association with each recommended integration.

In an embodiment, the visual representation of the recommendation comprises a rendering of a graph. The rendered graph may comprise nodes, representing all or a subset of the software services currently utilized by the user, and edges between two or more nodes, representing existing connections between the software services represented by those nodes (i.e., integrations that the user has already implemented). The rendered graph may also highlight each gap (i.e., missing edges, representing missing connections), between the software services represented as nodes in the graph, that represents one of the recommended integration(s). It should be understood that each recommended integration represents a solution to one of these highlighted gaps, such that there is a one-to-one correspondence between gaps and recommended integrations. A gap may be highlighted by an edge that is distinguished from (e.g., a different color or style than) edges representing existing connections, or may be represented in some other manner.

Module 335 may receive the user's selection of at least one of the recommended integration(s). In particular, the user may input a selection of at least one of the recommended integration(s) into the chat frame (e.g., as a natural-language expression) or select an input associated with at least one of the recommended integrations. AI agent 170 receives this user selection, within the chat frame, of at least one of the recommended integration(s). Module 340 may be triggered for each selected recommended integration. It should be understood that the user could also reject the recommended integrations and/or end the real-time chat session, in which case process 300 may end.

Assuming the user has selected a recommended integration, module 340 may retrieve source data 345 for the recommended integration. Source data 345 may be hosted on a third-party system 140A. Alternatively, source data 345 may be hosted within computing environment 150. In either case, module 340 may connect to the system, hosting source data 345, via an application programming interface, and query source data 345 via a call to a function (e.g., GET function) of the application programming interface. The retrieved source data 345 may be provided to module 350.

Module 350 may transform the data in some manner. This transformation may comprise mapping source data 345 from an input schema to an output schema, deriving new data from or otherwise based on source data 345, and/or otherwise manipulating source data 345 to produce target data. The transformed data may be provided to module 355.

Module 355 may update (or publish) target data 360 based on the transformed data. For example, target data 360 may comprise the transformed data or may otherwise be derived from the transformed data. Target data 360 may be hosted on a third-party system 140B, which may be the same as or different than third-party system 140A. Alternatively, target data 360 may be hosted within computing environment 150. In either case, module 355 may connect to the system, hosting target data 360, via an application programming interface, and update target data 360 via a call to a function (e.g., SET function) of the application programming interface.

Modules 340, 350, and 355 represent a simple integration between a source and a target. It should be understood that this is just one common framework for an integration, used for illustration purposes, and should not be considered the only possible framework. Other frameworks may involve no source data 345, multiple sources of source data 345, no target data 360, multiple targets for target data 360, no transformation, multiple iterations of retrieving, transforming, and/or updating data, decision-based branching, and/or the like. Thus, it should be understood that, in alternative examples, one or more of modules 340, 350, and 355 may be omitted, combined in a different order, combined with different modules, replaced with a different arrangement of modules, and/or the like. More generally, in response to the user selection of a recommended integration (e.g., in module 335), an integration of data is performed (e.g., by AI agent 170, or another AI agent or function of platform 110) between the connectable set of software services that is represented by the selected recommended integration.

Regardless of the particular integration that is performed after module 335, module 365 may prompt the user to automate the integration that was performed. In particular, module 365 may display a prompt within the chat frame of the real-time chat session. The prompt may be a predefined prompt (e.g., that AI agent 170 always uses to request the user information), or may be dynamically generated by model 172 (e.g., a generative language model) in real time. At a high level, AI agent 170 may prompt the user, within the chat frame, to generate an integration process 160 that automates the recommended and recently performed integration.

Assuming the user has decided to automate the integration that was performed, module 370 may receive the user's request. In particular, the user may respond to the prompt, displayed by module 365, with an affirmation, in natural language or by selecting an input. In the event that the affirmation is expressed as natural language within the real-time chat session, the sentiment of the user's response (e.g., classification of the user's response as an affirmation) may be determined by model 172 (e.g., a generative language model). The user's affirmation may trigger module 375. In other words, the user's affirmation to generating the integration process 160 may be received within the chat frame, and the integration process 160 may be generated in response to the user affirmation.

Module 375 may generate an integration process 160 that implements the integration that was performed between modules 335 and 365 (e.g., represented as modules 340, 350, and 355, in the illustrated example). In particular, module 375 may generate a plurality of pre-built steps, arranged in a particular configuration, to perform the integration. The steps may be pre-configured as much as possible. However, some steps may still need to be further configured or customized by the user. Once integration process 160 has been generated, a link or other input for accessing integration process 160 may be provided to the user. In particular, a prompt with a link to a virtual canvas for configuring integration process 160 may be displayed within the chat frame of the real-time chat session. The prompt may be a predefined prompt (e.g., that AI agent 170 always uses to request the user information), or may be dynamically generated by model 172 (e.g., a generative language model) in real time.

In response to the user's selection of the input (e.g., link) within the chat frame, the graphical user interface (e.g., of user interface 115) may be redirected to a screen that comprises a virtual canvas on which shapes, representing pre-built elements of the generated integration process 160, are pre-positioned and pre-connected, and which are draggable and droppable within the virtual canvas. In other words, the virtual canvas may be pre-populated with shapes and connections, representing the steps and data flow of the integration process 160 that was generated by module 375. Embodiments of the virtual canvas are described in the GUI patents. As disclosed in these embodiments, the graphical user interface may comprise a virtual canvas over which a user may drag and drop shapes, representing steps that perform specific functions, and connect the shapes to define data flows between respective steps. Thus, the user may easily modify and/or customize integration process 160 by simply adding, configuring, and connecting shapes in an intuitive manner, within a low-code integration environment. The user may utilize the virtual canvas to modify integration process 160, finish configuring integration process 160, analyze and/or test integration process 160, deploy integration process 160 to the integration platform that is managed by the user, and/or the like.

Unlike state-of-the-art processes, which are entirely user-driven and do not proactively make recommendations on integrations, embodiments of process 300 proactively prompt the user to perform the diagnostics test, executes the diagnostics test to identify candidate integrations, and recommends one or more of these candidate integrations to the user, within an easy-to-use and understand real-time chat session with AI agent 170. Process 300 may also execute the integration and provide the user with the option to automatically generate an integration process 160 that implements the integration in an automated manner. Thus, users can easily and intuitively use the real-time chat session with AI agent 170 to identify and fill gaps or blind spots within their integration platforms. This enables users to build more robust, efficient, effective, and comprehensive integration platforms that benefit from the synergy between different software services.

### 4. Diagnostics Test

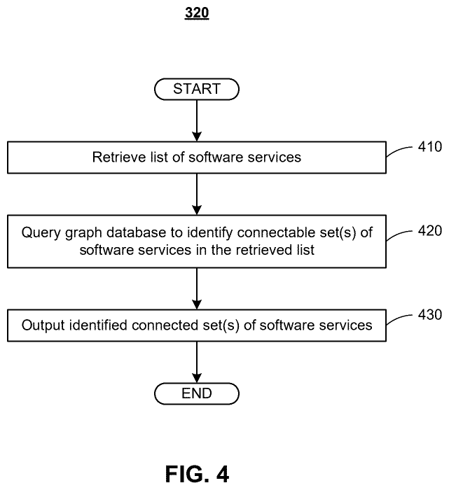

FIG. 4 illustrates an example of the diagnostics test, executed by module 320, according to an embodiment. While module 320 is illustrated with a certain arrangement and ordering of subprocesses, module 320 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 410 may retrieve a list of software services utilized by the user, within and/or external to computing environment 150, for example, via an application programming interface of a service management system. In particular, subprocess 410 may query a directory of software services, associated with the user's account, to obtain a list of all software services utilized by the user. The query may be performed by connecting to the service management system, hosting the directory of software services, via a service-management application programming interface, and executing a call to a function (e.g., GET function) of the service-management application programming interface that returns the list of software services from the directory of software services. To this end, AI agent 170 may utilize a connector that is configured to access the application programming interface of the service management system. The connector may be implemented as a tool 174 that is utilized by AI agent 170.

As an example, the service management system may be a centralized sign-on service, such as Okta™. A centralized sign-on service may maintain a directory of software services for which a same or single sign-on is provided. It should be understood that this is just one example, and that the list of services may be provided by any other service which maintains a directory of software services utilized by the user. Examples of software services, which may be included in such a directory, include, without limitation, customer relationship management (CRM) services, inventory or supply chain services, procurement services, invoicing services, accounting services, payment services, billing services, shipping services, information security services, employee management services, asset management services, risk management services, auditing services, and the like.

Subprocess 420 may identify connections, between services in the list of services that was retrieved by subprocess 410, in a graph database of crowd-sourced integration processes. In particular, platform 110 may maintain a graph database of all connected software services, represented by integration processes 160 within computing environment 150. The graph database may be built from historical implementations of integration processes 160, managed by a plurality of users, within computing environment 150. Graph database may be built and/or continually maintained by another AI agent or function of platform 110.

An example of a suitable graph database is Neo4j™ by Neo4j Inc. of San Mateo, California. Neo4j™ is a graph database management system that stores data in graphs and is designed to handle complex relationships between data points. However, it should be understood that other graph databases or other types of databases may be used instead. In an embodiment, the graph database represents a graph comprising nodes and edges. Each node may represent a software service utilized within computing environment 150 (e.g., of an iPaaS platform), and each edge, between a pair of nodes, may represent a connection implemented between the pair of software services, represented by that pair of nodes, within computing environment 150. The graph database may comprise a plurality of independent subgraphs, since not every software service may be connected to every other software service, such that connected sets of software services may form disconnected islands within the overall graph.

The graph database may be built from crowd-sourced historical data. In particular, historical integration data may be collected from a plurality of integration platforms managed through and executed by an iPaaS platform, such as the Boomi® iPaaS platform. The iPaaS platform may support a plurality of integration platforms, each managed by a different organizational account that is associated with one or more user accounts. In this case, the historical data may represent a massive repository (e.g., data lake) of previously implemented integration processes 160 that is very diverse in terms of structures, configurations, applications, inputs and outputs, and the like, and potentially crowd-sourced from a diverse group of organizations. The service endpoints in this repository represent software services and are converted into nodes within the graph, and the relationships between these service endpoints are converted into edges within the graph. The graph database may be updated periodically or continuously (e.g., in real time) as new integration processes 160 are implemented, within computing environment 150, by users of platform 110. In other words, computing environment 150 provides a data pipeline to the graph database.

At least a subset, and potentially all, of these integration processes 160, represented within the graph database, may represent a connection between two or more software services (e.g., a software service that manages source data 345 and a software service that manages target data 360). Subprocess 420 may query the graph database for all connected sets of software services, based on the list of software services retrieved in subprocess 410. In particular, subprocess 420 may query the graph database to return all connected sets of software services, within the graph database, that consist of software services within the retrieved list of software services. For example, assume that the graph database comprises a first node, representing Software Service A, connected by an edge to a second node, representing Software Service B. In this case, there is a connected set consisting of Software Service A and Software Service B. If the list of software services, utilized by the user, includes both Software Service A and Software Service B, this connected set would be returned in response to the query. On the other hand, if the list of software services includes Software Service A, but not Software Service B, this connected set would not be returned in the response to the query. While a connected set of software services may typically consist of a pair of software services, it should be understood that a connected set of software services could comprise a single software service or three or more software services. It should be understood that a connected set of software services in the graph database represents a connectable set of software services for the user. Thus, the query of graph database identifies one or more connectable sets of software services in the retrieved list of software services utilized by the user.

Subprocess 430 may output the identified connectable set(s) of software services as candidate integrations for recommendation. It should be understood that each of these candidate integrations represents an integration process 160 that has been implemented by at least one other user in computing environment 150 for software services that are utilized by the current user. Subprocess 430 may filter out any connectable sets of software services that have already been implemented by the current user, since there is no reason to recommend an integration that has already been implemented by the user. This filter may be implemented by comparing every connectable set of software services, output by subprocess 420, to existing connected sets of software services that have already been implemented by the user. For example, if the user has already implemented an integration between Software Service A and Software Service B, this connected set may be filtered out from the output of subprocess 420.

In some cases, the query of the graph database may return no connectable sets of software services. In this case, subprocess 430 may output an indication that no connectable sets of software services were identified.

### 5. Graphical User Interface

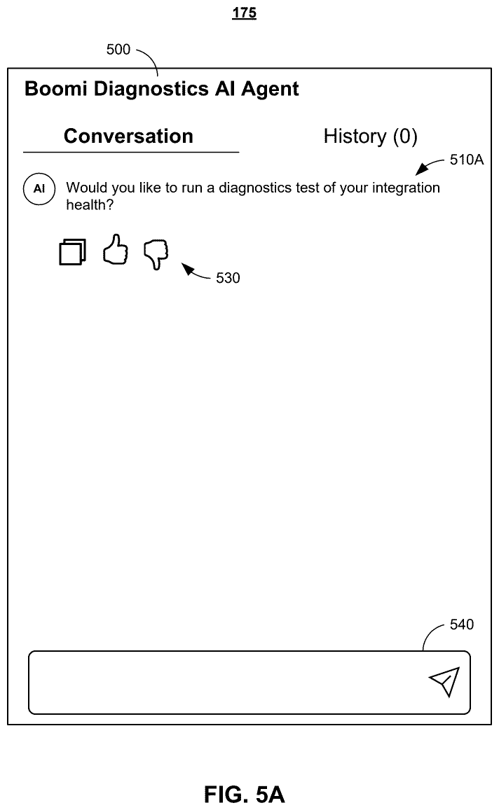

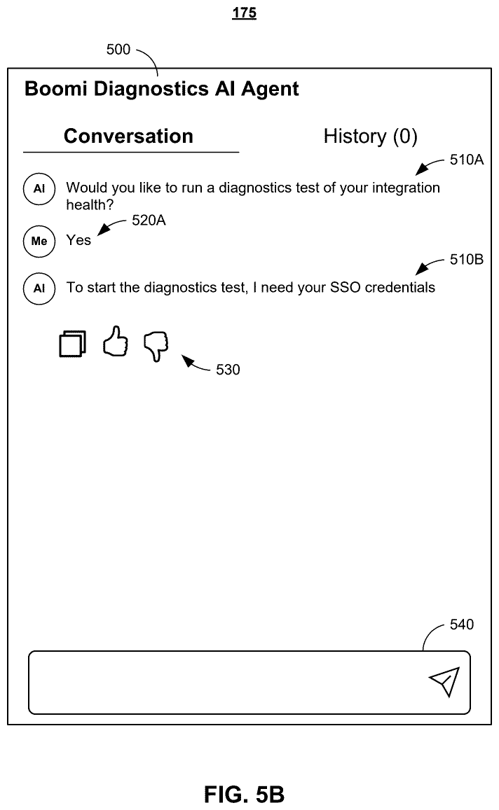

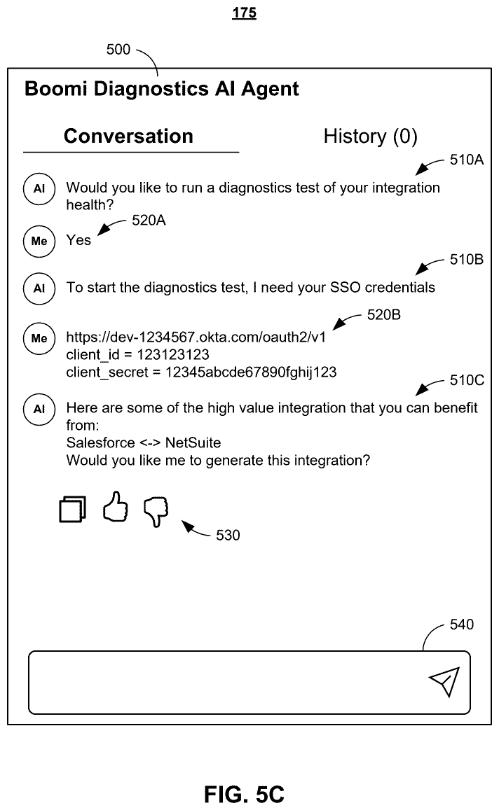

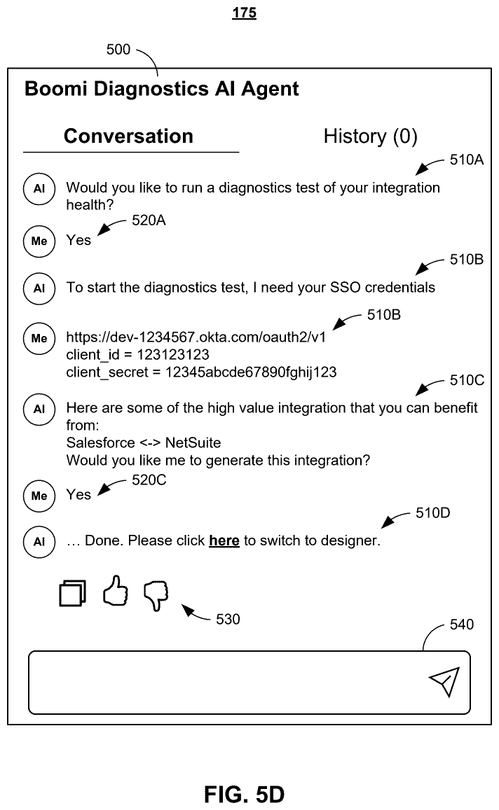

FIGS. 5A-5D illustrate a chat frame 500 of user interface 175 of AI agent 170 for proactively recommending integrations, according to an embodiment. Chat frame 500 may enable a user to converse with AI agent 170 in natural language, within a real-time chat session that may be triggered by module 305. Chat frame 500 may comprise one or more inputs 530 associated with the most recent agent expression 510 by AI agent 170. Inputs 530 may comprise an input for copying agent expression 510 to a clipboard of user system 140, an input (e.g., thumbs-up icon) for providing positive feedback, an input (e.g., thumbs-down icon) for providing negative feedback, and/or the like. Chat frame 500 may also comprise an input textbox 540 via which the user may input a user expression 520.

As used herein, a reference numeral with an appended letter will be used to refer to a specific component, whereas the same reference numeral without any appended letter will be used to refer collectively to a plurality of the component or to refer to a generic or arbitrary instance of the component. Thus, for example, the term “agent expressions 510” refers collectively to agent expressions 510A, 510B, 510C, and 510D, and the term “agent expression 510” may refer to any single one of agent expressions 510A, 510B, 510C, or 510D.

In FIG. 5A, module 305 has triggered module 310 to open chat frame 500, initiate a real-time chat session between the user and AI agent 170, and prompt the user to run a diagnostic. The trigger may have been a user action, such as the user signing into a user account on platform 110, selecting an input within user interface 115, explicitly interacting with AI agent 170, attempting to create an integration process 160, or the like, or may be a system event, such as the expiration of a periodic timer, a background analysis of the user's integration platform (e.g., that reveals gaps in the user's integrations), or the like. The prompt is illustrated as agent expression 510A, which asks the user, “Would you like to run a diagnostics test on your integration health?” The user may provide feedback on agent expression 510A using inputs 530, and respond to the prompt using textbox input 540.

In FIG. 5B, the user has responded, “Yes,” to run the diagnostics test (e.g., via textbox input 540), as illustrated by user expression 520A. To start the diagnostics test, AI agent 170 may need information, such as the user's credentials for the service management system. In this example, the system is a centralized sign-on service, such as Okta™. Thus, AI agent 170 requests the user to supply these credentials, as illustrated by agent expression 510B. Again, the user may provide feedback on agent expression 510B using inputs 530, and respond to the prompt using textbox input 540.

In FIG. 5C, the user has responded with credentials (e.g., via textbox input 540), as illustrated by user expression 520B, which are received as user information by module 315. At this point, module 320 may execute the diagnostics test, using the provided credentials to retrieve the list of software services in subprocess 410. Module 325 generates a recommendation, which, in this example, consists of an integration between Salesforce™, which is a CRM service, and NetSuite™, which is an ERP service. Module 330 displays this recommendation, as illustrated by agent expression 510C. Agent expression 510C also asks the user whether the user would like AI agent 170 to generate the recommended integration. Again, the user may provide feedback on agent expression 510C using inputs 530, and respond to the prompt using textbox input 540.

While not specifically illustrated, each recommended integration within expression 510C may be expandable. For example, each recommended integration may be associated with an input that enables the user to expand the recommended integration to view additional information about the recommended integration, and once expanded, enables the user to collapse the recommended integration to hide the additional information. This additional information may comprise the value of one or more metrics calculated for the recommended integration (e.g., frequency, utilization rate, performance, value, data volume, etc.), a description (e.g., value statement) of the recommended integration, and/or the like.

In FIG. 5D, the user has responded, “Yes,” to generating the recommended integration (e.g., via textbox input 540), as illustrated by user expression 520C, which is received by module 335. At this point, AI agent 170 may perform the integration (e.g., represented by modules 340, 350, and 355, in an example), and prompt the user to automate the integration via module 365, as illustrated by agent expression 510D. In this particular example, the prompt to automate the integration is a hyperlink to a designer screen of user interface 115. When the user clicks on the link, which may represent reception of a user request by module 370, AI agent 170 may generate an integration process 160, representing the performed integration, and provide a redirection to a designer screen. The designer screen may comprise a virtual canvas with a pre-built integration process 160, which the user can modify and/or configure, as described in the GUI patents and elsewhere herein. Again, the user may provide feedback on agent expression 510D using inputs 530, and respond to the prompt using textbox input 540.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, by an artificial intelligence (AI) agent, during a real-time chat session between a user and the AI agent within a chat frame of a graphical user interface:
perform a diagnostics test by
retrieving a list of software services utilized by the user via an application programming interface of a service management system, and
query a graph database to identify one or more connectable sets of software services in the retrieved list of software services, wherein the graph database represents a graph comprising nodes and edges, in which each node represents a software service utilized within a computing environment of an integration as a service (iPaaS) platform, and in which each edge represents a connection implemented between a pair of the software services within the computing environment;
generate a recommendation based on the identified one or more connectable sets of software services, wherein the recommendation comprises one or more recommended integrations, and wherein each of the one or more recommended integrations represents an integration of data between one of the one or more connectable sets of software services; and
display a visual representation of the recommendation in the chat frame.

2. The method of claim 1, wherein the diagnostics test is performed in response to a user input from the user within the chat frame.

3. The method of claim 2, wherein the user input is prompted by an initial agent input from the AI agent within the chat frame.

4. The method of claim 3, wherein the initial agent input is predefined.

5. The method of claim 3, wherein the chat frame is opened and the initial agent input is entered into the chat frame in response to a trigger.

6. The method of claim 5, wherein the trigger is an event that indicates that the user is attempting to create an integration process.

7. The method of claim 1, wherein the visual representation comprises a natural-language expression.

8. The method of claim 7, further comprising using the at least one hardware processor to, by the AI agent, generate the natural-language expression by:
generating a prompt based on the one or more connectable sets of software services; and
inputting the prompt to a generative language model to produce the natural-language expression.

9. The method of claim 1, further comprising using the at least one hardware processor to, by the AI agent, receive a user selection, within the chat frame, of at least one of the one or more recommended integrations.

10. The method of claim 9, further comprising using the at least one hardware processor to, in response to the user selection of the at least one recommended integration, perform the integration of data between the one of the one or more connectable sets of software services that is represented by the at least one recommended integration.

11. The method of claim 10, further comprising using the at least one hardware processor to, by the AI agent, prompt the user, within the chat frame, to generate an integration process that automates the at least one recommended integration.

12. The method of claim 11, further comprising using the at least one hardware processor to:
receive a user affirmation, within the chat frame, to generating the integration process; and
in response to the user affirmation, generate the integration process.

13. The method of claim 12, further comprising using the at least one hardware processor to, in response to a user selection of an input within the chat frame, redirect the user to a screen within the graphical user interface that comprises a virtual canvas on which shapes, representing pre-built elements of the generated integration process, are pre-positioned and pre-connected, wherein each of the shapes is draggable and droppable within the virtual canvas.

14. The method of claim 1, wherein the visual representation comprises, for each of the one or more recommended integrations, an identifier of each software service in the connectable set of software services between which the recommended integration represents the integration of data.

15. The method of claim 14, wherein the visual representation further comprises, for each of the one or more recommended integrations, a value of each of one or more metrics associated with that recommended integration.

16. The method of claim 15, wherein the value of at least one of the one or more metrics is derived from historical data collected from a plurality of implementations of integration processes, managed by a plurality of users, within the computing environment.

17. The method of claim 1, further comprising using the at least one hardware processor to build the graph database from historical implementations of integration processes, managed by a plurality of users, within the computing environment.

18. The method of claim 1, wherein the service management system comprises a centralized sign-on service.

19. A system comprising:
at least one hardware processor; and
software that is configured to, when executed by the at least one hardware processor, by an artificial intelligence (AI) agent, during a real-time chat session between a user and the AI agent within a chat frame of a graphical user interface,
perform a diagnostics test by
retrieving a list of software services utilized by the user via an application programming interface of a service management system, and
query a graph database to identify one or more connectable sets of software services in the retrieved list of software services, wherein the graph database represents a graph comprising nodes and edges, in which each node represents a software service utilized within a computing environment of an integration as a service (iPaaS) platform, and in which each edge represents a connection
implemented between a pair of the software services within the computing environment,
generate a recommendation based on the identified one or more connectable sets of software services, wherein the recommendation comprises one or more recommended integrations, and wherein each of the one or more recommended integrations represents an integration of data between one of the one or more connectable sets of software services, and
display a visual representation of the recommendation in the chat frame.

20. A non-transitory computer-readable medium having instructions stored therein, wherein the instructions, when executed by a processor, cause the processor to, by an artificial intelligence (AI) agent, during a real-time chat session between a user and the AI agent within a chat frame of a graphical user interface:
perform a diagnostics test by
retrieving a list of software services utilized by the user via an application programming interface of a service management system, and
query a graph database to identify one or more connectable sets of software services in the retrieved list of software services, wherein the graph database represents a graph comprising nodes and edges, in which each node represents a software service utilized within a computing environment of an integration as a service (iPaaS) platform, and in which each edge represents a connection implemented between a pair of the software services within the computing environment;
generate a recommendation based on the identified one or more connectable sets of software services, wherein the recommendation comprises one or more recommended integrations, and wherein each of the one or more recommended integrations represents an integration of data between one of the one or more connectable sets of software services; and
display a visual representation of the recommendation in the chat frame.
